(19) United States
(12) Patent Application Publication
(10) Pub. No.: US 2026/0300506 A1
(43) Pub. Date: Oct. 1, 2026

(54) A Processor Adapted to Detect a Poisoned Input and a Training Method Thereof

(71) Applicants: Robert Bosch GmbH, Stuttgart (DE); BOSCH GLOBAL SOFTWARE TECHNOLOGIES PRIVATE LIMITED, Bangalore (IN)

(72) Inventors: Manojkumar Somabhai Parmar, Ahmedabad (IN); Pavan Kulkarni, Hubli (IN); Govindarajulu Yuvaraj, Bengaluru (IN)

(21) Appl. No.: 19/479,097

(22) PCT Filed: Apr. 28, 2024
(86) PCT No.: PCT/EP2024/061706

§ 371 Date: Oct. 27, 2025

(30) Foreign Application Priority Data
Apr. 28, 2023 (IN) 2023 4103 0698

(51) Int. Cl. G06F 21/57; G06N 20/00

(52) U.S. Cl. CPC G06F 21/577; G06N 20/00; G06F 2221/033

(57) ABSTRACT

A processor adapted to detect a poisoned input from an input to be fed to an AI model and a training method thereof is disclosed. The processor is configured to record the behavior of the AI model in response to a set of pre-determined poisoned samples. The processor performs a vulnerability assessment based on the recorded behavior which is used to train a classifier model within the processor. Vulnerability assessment includes determining a threshold of poisoning for which the AI model misclassifies an input. During training the classifier is trained to identify a poisoned input based on feature values, feature distributions, and metadata of the set of pre-determined poisoned input.

### FIELD OF THE INVENTION

The present disclosure relates to the field of Artificial Intelligence security. In particular, it proposes a processor adapted to detect a poisoned input from input to be fed to an AI model and a training method thereof.

### BACKGROUND OF THE INVENTION

With the advent of data science, data processing and decision-making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically, the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

It is possible that some adversary may try to tamper/manipulate/evade the model in AI Systems to create incorrect outputs. The adversary may use different techniques to manipulate the output of the model. One of the simplest techniques used by the adversary is where the adversary sends queries to the AI system using his own test data to compute or approximate the gradients through the model. Based on these gradients, the adversary can then manipulate the input in order to manipulate the output of the Model. Another technique is wherein the adversary may manipulate the input data to bring an artificial output. In this invention we focus on poisoning. Adversarial data poisoning is defined as an effective attack against machine learning and threatens model integrity by introducing poisoned data into the training dataset. Since the model learns on poisoned dataset, it is bound to give incorrect results.

This will cause hardships to the original developer of the AI in the form of business disadvantages, loss of confidential information, loss of lead time spent in development, loss of intellectual properties, loss of future revenues etc. Data poisoning can render machine learning models inaccurate, possibly resulting in poor decisions based on faulty outputs. Hence there is a need for a method of detection of AI poisoning.

Brief description of the accompanying drawings

An embodiment of the invention is described with reference to the following accompanying drawings:

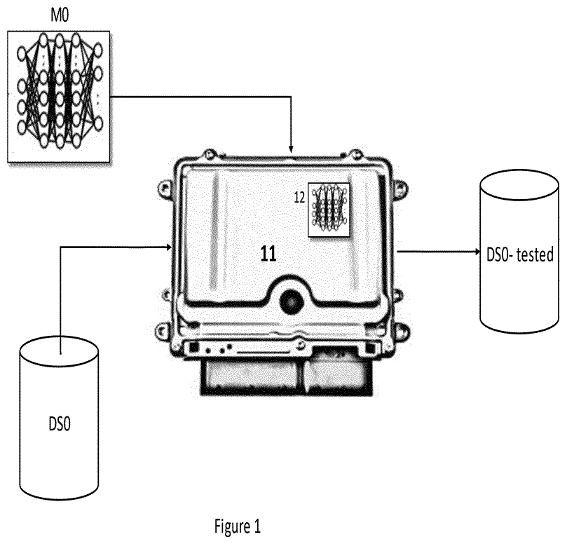

FIG. 1 depicts a processor (11) adapted to detect a poisoned input from an input to be fed to an AI model (M0);

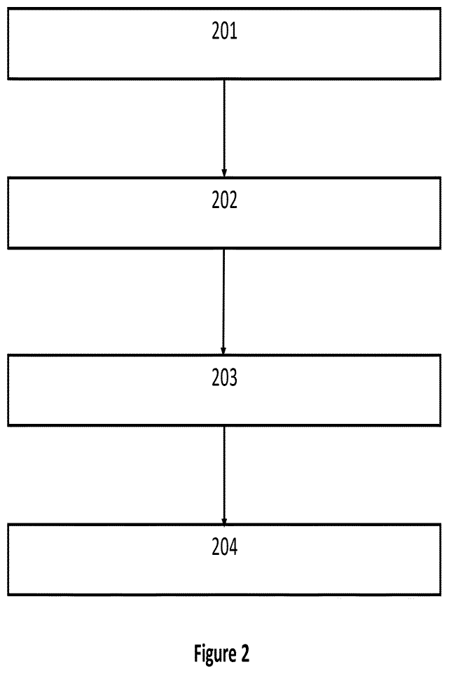

FIG. 2 illustrates method steps of training a processor (11) to detect a poisoned input from an input to be fed to the AI model (M0).

### DETAILED DESCRIPTION OF THE DRAWINGS

It is important to understand some aspects of artificial intelligence (AI) technology and artificial intelligence (AI) based systems or artificial intelligence (AI) system. Some important aspects of the AI technology and AI systems can be explained as follows. Depending on the architecture of the implements AI systems may include many components. One such component is an AI module. An AI module with reference to this disclosure can be explained as a component which runs a model.

A model can be defined as reference or an inference set of data, which is use different forms of correlation matrices. Using these models and the data from these models, correlations can be established between different types of data to arrive at some logical understanding of the data. A person skilled in the art would be aware of the different types of AI model (M0)s such as linear regression, naïve bayes classifier, support vector machine, neural networks and the like. It must be understood that this disclosure is not specific to the type of model being executed in the AI module and can be applied to any AI module irrespective of the AI model (M0) being executed. A person skilled in the art will also appreciate that the AI module may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. In a regression task, the model is trained based on labeled datasets, where the target labels are numeric values. Some of the typical applications of regressions are: Weather forecasting, Stock price predictions, House price estimation, energy consumption forecasting etc. Clustering or grouping is the detection of similarities in the inputs. The cluster learning techniques do not require labels to detect similarities. Learning without labels is called unsupervised learning. Unlabeled data is the majority of data in the world.

As the AI module forms the core of the AI system, the module needs to be protected against attacks. AI adversarial threats can be largely categorized into—model extraction attacks, inference attacks, evasion attacks, and data poisoning attacks. Inference attacks attempt to infer the training data from the corresponding output or other information leaked by the target model. Studies have shown that it is possible to recover training data associated with arbitrary model output. Ability to extract this data further possess data privacy issues. Evasion attacks are the most prevalent kind of attack that may occur during AI system operations. In this method, the attacker works on the AI algorithm's inputs to find small perturbations leading to large modifications of its outputs (e.g., decision errors) which leads to evasion of the AI model (M0). In poisoning attacks, the adversarial carefully inject crafted data to contaminate the training data which eventually affects the functionality of the AI system.

In Model Extraction Attacks (MEA), the attacker gains information about the model internals through analysis of input, output, and other external information. Stealing such a model reveals the important intellectual properties of the organization and enables the attacker to craft other adversarial attacks such as evasion attacks. This attack is initiated through an attack vector. In the computing technology a vector may be defined as a method in which a malicious code/virus data uses to propagate itself such as to infect a computer, a computer system or a computer network. Similarly, an attack vector is defined a path or means by which a hacker can gain access to a computer or a network in order to deliver a payload or a malicious outcome. A model stealing attack uses a kind of attack vector that can make a digital twin/replica/copy of an AI module.

This invention primarily focuses on detecting whether or not an input query that is to fed to an AI model (M0) is poisoned. In poisoning, the attacker's goal is to get their poisoned inputs to be accepted as training data. AI model (M0)s are retrained with newly collected data at certain intervals, depending on their intended use. Since poisoning usually happens over time, and over some number of training cycles, it can be hard to tell when prediction accuracy starts to shift. Hence the aim of this invention is to design a module/hardware that detects and filters poisoned input before it is fed to an AI model (M0) at any stage.

FIG. 1 depicts a processor (11) adapted to detect a poisoned input from an input to be fed to an AI model (M0). The AI model (M0) is deployed in a real-world application, for example voice/face recognition, stock prediction, disease detection. The processor (11) comprises at least a classifier model (12) and is in communication with the AI model (M0). The classifier model (12) is a type of artificial intelligence model configured to classify an input into two or more classes.

The processor (11) comprises other components known to a person skilled in the art, such as receivers and transmitters. It may be implemented as a function of microcontrollers, firmware, an application specific integrated circuit (ASIC), and/or a field programmable gate array (FPGA). These various modules/components can either be a software embedded in a single chip or a combination of software and hardware where each module and its functionality is executed by separate independent chips connected to each other to function as the system. For example, the classifier model (12) mentioned herein after can be a software residing in the system or the cloud or embodied within an electronic chip. Alternatively, we can have neural network chips that are specialized silicon chips, which incorporate AI technology and are used for machine learning.

As used in this application, the terms “component,” “model,” “interface,” are intended to refer to a computer-related entity or an entity related to, or that is part of, an operational apparatus with one or more specific functionalities, wherein such entities can be either hardware, a combination of hardware and software, software, or software in execution. As further yet another example, interface(s) can include input/output (I/O) components as well as associated processor (11), application, or Application Programming Interface (API) components. Similarly, the classifier model (12) could be a hardware or a software combination of these modules or could be deployed remotely on a cloud or server. These various modules can either be a software embedded in a single chip or a combination of software and hardware where each module and its functionality is executed by separate independent chips connected to each other to function as a system.

The processor (11) is characterized by it's functionality and configuration. The processor (11) is configured to: feed a set of pre-determined poisoned samples (DS0) to the AI model (M0); record the behavior of the AI model (M0) in response to the set of pre-determined poisoned samples (DS0); perform a vulnerability assessment based on the recorded behavior; train a classifier model (12) based on the vulnerability assessment; receive the input to be fed to the AI model (M0); execute the classifier model (12) to detect poisoned input from the input to be fed to the AI model (M0).

Vulnerability assessment comprises determining a threshold of poisoning for which the AI model (M0) misclassifies an input. During training the classifier is trained to identify a poisoned input based on feature values, feature distributions, and meta-data of set of pre-determined poisoned input. Once the classifier is trained, it receives the input to be fed to the AI model (M0) and detects a poisoned input. Its filters out the poisoned input, allowing only the clean input to be fed to the AI model (M0).

It should be understood at the outset that, although exemplary embodiments are illustrated in the figures and described below, the present disclosure should in no way be limited to the exemplary implementations and techniques illustrated in the drawings and described below.

FIG. 2 illustrates method steps of training a processor (11) to detect a poisoned input from an input to be fed to the AI model (M0). The processor (11) and the AI model (M0) have been explained in accordance with FIG. 1. For clarity it is reiterated that said AI model (M0) is in communication with the processor (11) and said processor (11) comprises at least a classifier model (12).

Method step 201 comprises feeding a set of pre-determined poisoned samples (DS0) to the AI model (M0) by means of the processor (11). The set of pre-determined poisoned samples (DS0) poisoned input queries created through techniques known to a person skilled in the art such as gradient based attacks, pixel or patch/pattern attacks. The example of patch attack is the image of a cat with patches at specific places that induces the AI model (M0) to misclassify it as a dog.

Method step 202 comprises recording the behavior of the AI model (M0) in response to the set of pre-determined poisoned samples (DS0). How the AI model (M0) responds to these poisoned queries is analyzed. Method step 203 comprises performing a vulnerability assessment by means of the processor (11) based on the recorded responses. Performing a vulnerability assessment comprises determining a threshold of poisoning for which the AI model (M0) misclassifies an input. Taking cue from the previous example, for what amount patch attack i.e. patches on the image of a cat, does the AI model (M0) misclassifies it as a dog.

Method step 204 comprises training the classifier model (12) based on the vulnerability assessment by means of the processor (11). During training the classifier model (12) is fed with both clean samples and poisoned samples. The poisoned samples are labelled in a supervised manner. This makes the classifier model (12) during training, identify a poisoned input based on feature values, feature distributions, and meta-data of the set of pre-determined poisoned input.

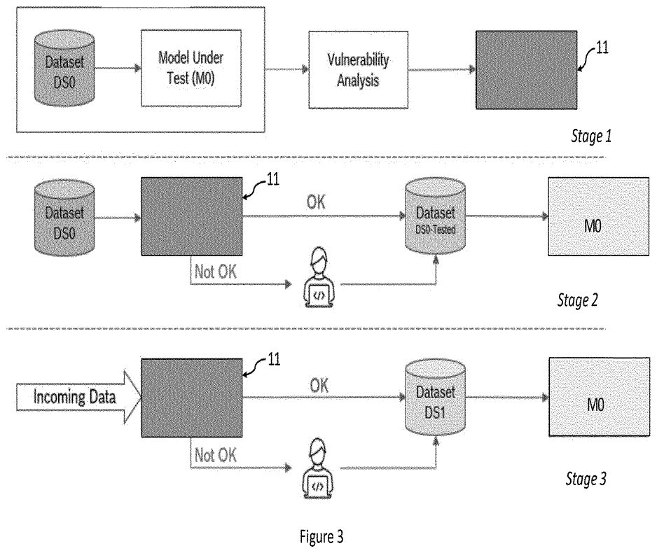

The classifier model (12) has been trained in accordance with method steps. FIG. 3 depicts three stages of deployment of the processor (11). In the first stage the processor (11) is configured i.e. the classifier model (12) within the processor (11) is trained based on the vulnerability assessment. In the second stage processor (11) is deployed in training/re-training stage of the AI model (M0). Here it ensures that the AI model (M0) is trained on only on clean dataset (DS0-tested). In the final stage wherein the AI model (M0) is deployed in a real-world application, the processor (11) acts like a poisoning sniffer/filter that allows only the non-poisoned queries to reach the AI model (M0).

A real world example of the AI Model (M0) could be classification as in—Facial recognition or regression as in—Stock price prediction. When an attacker gains access to a subset of the training dataset, he could poison the training samples (as less as 1-2%) to create adversarial impacts on the model's performance. The consequences could be—deteriorated model performance after training, hidden backdoors that the attacker could leverage for targeted attacks. These could directly or indirectly affect the performance of the system and even jeopardize the system completely, which could be fatal in mission critical applications. In Facial Recognition the system associated could be a security access control to a restricted facility. The poisoned samples are usually secret visually imperceptible patches embedded in the legitimate samples, where person-1 who ideally has no access could be mapped to full access through poisoned samples. The poisoned samples here will be person-1 with embedded patches. The proposed invention attempts to provide a technical solution to such real-world problems.

It must be understood that while these methodologies describe only a series of steps to accomplish the objectives, these methodologies are implemented in the processor (11) and AI model (M0), which may be a combination of hardware or software or a combination thereof. Further the embodiments explained in the above detailed description are only illustrative and do not limit the scope of this invention. Any modification to the processor (11) adapted to detect a poisoned input and a training method thereof form a part of this invention. scope of this invention is limited only by the claims.

1. A processor adapted to detect a poisoned input from an input to be fed to an AI model, the processor comprising at least a classifier model said processor in communication with the AI model, said processor configured to:
feed a set of pre-determined poisoned samples to the AI model;
record the behavior of the AI model in response to the set of pre-determined poisoned samples;
perform a vulnerability assessment based on the recorded behavior;
train a classifier model based on the vulnerability assessment;
receive the input to be fed to the AI model; and
execute the classifier model to detect poisoned input from the input to be fed to the AI model.

2. The processor adapted to detect a poisoned input as claimed in claim 1, wherein vulnerability assessment comprises determining a threshold of poisoning for which the AI model misclassifies an input.

3. The processor adapted to detect a poisoned input as claimed in claim 1, wherein the classifier is trained to identify a poisoned input based on feature values, feature distributions, and meta-data of the set of pre-determined poisoned samples.

4. A method of training a processor to detect a poisoned input from an input to be fed to an AI model, said AI model in communication with the processor, said processor comprising at least a classifier model, the method comprising:
feeding a set of pre-determined poisoned samples to the AI model by way of the processor;
recording behavior of the AI model in response to the set of pre-determined poisoned samples;
performing a vulnerability assessment by way of the processor based on the recorded responses; and
training the classifier model based on the vulnerability assessment by way of the processor.

5. The method of training a processor to detect a poisoned input as claimed in claim 4, wherein performing a vulnerability assessment comprises determining a threshold of poisoning for which the AI model misclassifies an input.

6. The method of training a processor to detect a poisoned input as claimed in claim 4, wherein training the classifier comprises identifying a poisoned input based on feature values, feature distributions, and meta-data of the set of pre-determined poisoned input.
